(19) United States
(12) Patent Application Publication
(10) Pub. No.: US 2022/0389197 A1
(43) Pub. Date: Dec. 8, 2022

(54) COMPOSITE MATERIAL

(71) Applicant: WOODLY OY, Helsinki (FI)

(72) Inventors: Martta ASIKAINEN, Helsinki (FI); Upi ANTTILA, Helsinki (FI); Tommi VUORINEN, Tampere (FI); Jari-Pekka KANKAANPAA, Tampere (FI); Mirja NYGARD, Tampere (FI)

(73) Assignee: WOODLY OY, Helsinki (FI)

(21) Appl. No.: 17/771,061

(22) PCT Filed: Oct. 21, 2020
(86) PCT No.: PCT/FI2020/050692

§ 371 Date: Apr. 22, 2022

(30) Foreign Application Priority Data
Oct. 22, 2019 (FI) 20195902

(51) Int. Cl. C08L 1/14

(52) U.S. Cl. CPC C08L 1/14; C08L 2205/03; C08L 2203/30

(57) ABSTRACT

The invention concerns a thermoplastic composite material having a component A, which is a continuous matrix based on a homogeneous polymer mixture, and component B, which includes solid particles and/or fibers. Furthermore, the invention relates to a method for manufacturing a thermoplastic composite material as well as use thereof.

### TECHNICAL FIELD

The present disclosure relates to a composite material. Especially, a thermoplastic composite material is disclosed comprising a continuous matrix based on a homogeneous polymer mixture comprising a polymer composition, and solid particles and/or fibers distributed within the continuous matrix.

### BACKGROUND

Composite materials are materials made from two or more substances or materials having different physical or chemical properties so that the resulting composite material has a different performance than any of the materials alone.

Biocomposites are composite materials where at least one of the components is biobased or biodegradable. Thermoplastic biocomposites contain a thermoplastic matrix and a fiber or a solid filler. Either the thermoplastic matrix, or the filler can be biobased or biodegradable. When the thermoplastic matrix is biobased or biodegradable, the filler can be derived either from biobased resources or it can be a synthetic fiber, such as glass fiber or carbon fiber, or even contain metals.

There are many applications for biocomposites, the most important being decking, automotive, siding and fencing. Also, technical parts, furniture and consumer goods are being produced. Biocomposites find applications in different types of consumer goods such as kitchenware (cutlery, tableware, dishes and containers), beauty items such as combs or handles for hairbrushes and make up brushes. Biocomposites can also be used as the material for decorative items and toys and pencils. Also, electronics casings, such as loudspeaker or radio covers are being made of biocomposites.

Biocomposites are often processed to these items with injection molding, extrusion techniques and thermoforming techniques.

### SUMMARY

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject-matter.

The invention concerns a thermoplastic composite material, which comprises in combination
component A, which is a continuous matrix based on a homogeneous polymer mixture comprising a polymer composition comprising cellulose acetate propionate (CAP), and a second polymer selected from the group consisting of polybutylene succinate (PBS), polypropylene succinate (PPS), polybutylene succinate adipate (PBSA), polybutylene adipate terephthalate (PBAT), polylactic acid (PLA), polycaprolactone (PCL), polybutylene adipate (PBA), polyhydroxyalkanoate (PHA), polyhydroxybutyrate (PHB), polyethylene furanoate (PEF), polybutylene terephthalate (PBT), polybutylene succinate terephthalate (PBST), and any polyester containing sebacic and/or azelaic acid and/or dodecanedioic acid as dicarboxylic acid alone or in combination with terephthalic acid, and any combination of these, and
a component B, which comprises solid particles and/or fibers distributed within said continuous matrix.

The thermoplastic composite material comprises in combination component A and component B in an amount of at least 80 weight-% of the total weight of the thermoplastic composite material.

The thermoplastic composite material comprises at least 1 weight-% of component B based on the total weight the thermoplastic composite material.

Further, the invention relates to an article manufactured from the thermoplastic composite material.

The invention also relates to a method for manufacturing a thermoplastic composite material. The method comprises the following steps:
obtaining a homogenous polymer mixture comprising component A, which comprises a polymer composition comprising cellulose acetate propionate (CAP), and a second polymer selected from the group consisting of polybutylene succinate (PBS), polypropylene succinate (PPS), polybutylene succinate adipate (PBSA), polybutylene adipate terephthalate (PBAT), polylactic acid (PLA), polycaprolactone (PCL), polybutylene adipate (PBA), polyhydroxyalkanoate (PHA), polyhydroxybutyrate (PHB), polyethylene furanoate (PEF), polybutylene terephthalate (PBT), polybutylene succinate terephthalate (PBST), and any polyester containing sebacic and/or azelaic acid and/or dodecanedioic acid as dicarboxylic acid alone or in combination with terephthalic acid, and any combination of these, and
feeding the obtained homogenous polymer mixture comprising component A and a component B, comprising solid particles and/or fibers, to a compounder and mixing, to obtain a thermoplastic composite material wherein component B is distributed within component A, and
cooling the obtained thermoplastic composite material.

Further, the invention concerns use of the thermoplastic composite material in the manufacture of articles selected from the group consisting of packaging materials, deckings, automotive parts, paneling, sidings, fencing materials, technical parts, furniture, consumer goods; such as kitchenware, cutlery, tableware, cutting boards, trays, dishes, or beauty items, such as combs, hairbrushes, make up brushes and/or their handles, decorative items, toys, holders, retainers, containers, vases, pots, cases, boxes, frames, fishing equipment, pens and/or pencils, electronics casings and covers; such as loudspeaker casings, radio covers, mobile phone covers, other casings and/or covers.

### BRIEF DESCRIPTION OF THE DRAWINGS

The accompanying drawings, which are included to provide a further understanding of the embodiments and constitute a part of this specification, illustrate various embodiments. In the drawings:

FIG. 1 illustrates an in-situ generated web of polypropylene in a polymer matrix.

### DETAILED DESCRIPTION

The present invention is based on the finding that high-quality composite materials can be obtained using as a continuous matrix a homogeneous polymer mixture comprising a polymer composition comprising cellulose acetate propionate (CAP), and a second polymer selected from the group consisting of polybutylene succinate (PBS), polypropylene succinate (PPS), polybutylene succinate adipate (PBSA), polybutylene adipate terephthalate (PBAT), polylactic acid (PLA), polycaprolactone (PCL), polybutylene adipate (PBA), polyhydroxyalkanoate (PHA), polyhydroxybutyrate (PHB), polyethylene furanoate (PEF), polybutylene terephthalate (PBT), polybutylene succinate terephthalate (PBST), and any polyester containing sebacic and/or azelaic acid and/or dodecanedioic acid as dicarboxylic acid alone or in combination with terephthalic acid, and any combination of these.

In the thermoplastic composite material according to the invention, a component B reinforces the polymer matrix, component A, and the resulting composite material has superior mechanical properties, such as the impact strength.

The invention can provide a thermoplastic composite material based mainly on renewable materials, which can be used to manufacuture various articles. The articles, which can be produced from the composite material have properties that are as good or better compared to materials based purely on fossil resources. The new composite and the articles manufactured therefrom could replace materials based on purely fossil raw-materials. Thus, the composite material of the invention, and the articles manufactured therefrom provide a more sustainable material option for grocers and consumers.

20

The thermoplastic composite material according to the invention has several advantages:
the impact resistance increases significantly compared to using only the homogenous polymer composition,
   especially with the combination of either wood chips and/or polypropylene, when used in small amounts, even 1 weight-% is enough,
impact strength is very high and comparable to technical plastics such as ABS.

It is quite normal that impact resistance is reduced when a composite is produced. Thus, the composite material of the invention shows surprising advantages.

Further advantages are that the composite materials according to the invention can be processed by the same machines and methods as conventional plastics. The product range is also wide.

The composite material according to the invention also has the advantage of improving processability in injection molding applications.

A novel typical product based on the composite material of the invention could comprise about 40 weigh-% of wood-based component B, such as wood chips, and about 60 weight-% of component A. In this case the product may be well over 50 weigh-% wood-based, and it has been shown that it is still very compact and stable.

The invention provides a thermoplastic composite material, which comprises in combination
a component A, which is a continuous matrix based on a homogeneous polymer mixture comprising a polymer composition comprising cellulose acetate propionate (CAP), and a second polymer selected from the group consisting of polybutylene succinate (PBS), polypropylene succinate (PPS), polybutylene succinate adipate (PBSA), polybutylene adipate terephthalate (PBAT), polylactic acid (PLA), polycaprolactone (PCL), polybutylene adipate (PBA), polyhydroxyalkanoate (PHA), polyhydroxybutyrate (PHB), polyethylene furanoate (PEF), polybutylene terephthalate (PBT), polybutylene succinate terephthalate (PBST), and any polyester containing sebacic and/or azelaic acid and/or dodecanedioic acid as dicarboxylic acid alone or in combination with terephthalic acid, and any combination of these, and
a component B, which comprises solid particles and/or fibers distributed within said continuous matrix.

The thermoplastic composite material comprises component A and component B in combination in an amount of at least 80 weight-% of the total weight of the thermoplastic composite material.

The thermoplastic composite material comprises at least 1 weight-% of component B based on the total weight the thermoplastic composite material. Even a rather low amount of component B is sufficient to give improved properties, such as high impact strength.

“Homogenous polymer mixture” is a blend comprising two or more thermoplastic polymers. The homogeneous polymer mixture has only one phase. It also can have different physical properties compared to the mixture's component polymers in pure state. According to one very specific embodiment, the second polymer in the homogenous polymer mixture is PBS. CAP and PBS form a homogeneous polymer mixture, which has different properties than the polymers separately.

According to one embodiment of the invention, the solid particles are selected from the group consisting of wood dust, wood particles, heat treated wood particles, wood shavings, wood fibers, celluose fibers, nanocellulose, lignin fibers, carbon fibers, metal particles, glass fibers, textile fibers and thermoplastic polymer fibers, and any combination of these. All of these different particles and fibers give different properties and advantages to the thermoplastic composite material of the invention.

According to one embodiment of the invention, the composite material comprises 25 to 99 weight-% of component A, and 1 to 75 weight-% of component B, based on the total weight of the thermoplastic composite material.

According to one embodiment of the invention, the component A is a homogeneous polymer mixture comprising CAP and the second polymer in an amount of at least 80 weigh-%, preferably at least 90 weight-% based on the total weight of the weight of the homogenous polymer mixture.

According to one embodiment of the invention, component B comprises at least 80 weigh-%, typically at least 90 weight-% of the solid particles and/or fibers, based on the total weight of the solid particles and/or fibers. Component B may also comprise other materials such as pigments, fillers, additives etc. depending on what properites are needed for the end use of the composite material.

According to one embodiment of the invention, in component B, the sieve particle size of the solid particles and/or fibers is 1 μm to 3000 μm. Depending on the material of the particles, the sieve particle size may even be bigger, such as 1 μm to 5000 μm. Typically, the sieved particle size is in the range of 5 to 2000 μm. The particle size depends on what solid particles are used in the composite material. The sieved particle size may also be in the range of 10 to 1800 μm, 50 to 1500 μm, 100 to 1000 μm, or for example 200 to 800 μm.

According to one embodiment of the invention, the solid particles and/or fibers of component B are selected from the group consisting of wood dust, wood particles, heat treated wood particles, wood shavings, wood fibers, and any combination of these, with a sieve particle size in the range of 100 to 3000 μm, typically 200 to 2000 μm.

According to one embodiment of the invention, the composite material comprises 30 to 99 weight-% of component A, and 1 to 70 weight-% of component B, based on the total weight of the thermoplastic composite material. These amounts have been shown to be especially appropriate to obtain the improved properties of the composite material. The composite material may also compris for example 35 to 95 weight-% of component A, and 5 to 65 weight-% of component B, or 40 to 90 weight-% of component A, and 10 to 60 weight-% of component B, based on the total weight of the thermoplastic composite material.

According to one embodiment of the invention, component B comprises thermoplastic polymer fibers, which are fibers that are non-miscible to the continuous matrix. Thermoplastic polymer fibers may be for example polypropylene and/or polyethylene fibers. Especially, polypropylene has shown to improve the impact strength of the composite material and polyethylene fibers are expected to act similarly.

According to one embodiment of the invention, component B is selected from metal particles selected from the group consisting of copper, zinc and tungsten, and any combination of these.

According to one embodiment, component B is selected from the group consisting of talc, CaCO₃, carbon black and kaolin, and any combination or mixture of these. Thus, the compsite material may comprise inorganic fillers selected from the defined group or other commonly used inorganic fillers. Further, according to one embodiment, the composite material comprises a combination of an inorganic filler and another material as component B, such as wood particles or metal particles.

According to one embodiment, the homogenous polymer mixture comprises CAP in an amount of 5 to 95 weight-%, preferably 10 to 90 weight-%, more preferably 20 to 80 weight-%, and the second polymer in an amount of 5 to 95 weight-%, preferably 10 to 90 weight-%, more preferably 20 to 80 weight-%, based on the total weight of the polymer composition.

According to one embodiment, the total amount of CAP and the second polymer is at least 85 wt. %, preferably at least 90 wt. %, based on the total weight of the polymer composition the rest being other polymers and/or additives such as softeners, pigments, stabilizers and/or other additives for use in plastic compositions.

According to one embodiment, the homogenous polymer mixture comprises at least one softener. For example triethyl citrate (TEC).

According to one specific embodiment, the secand polymer is PBS and has a number average molar mass in the range of 30,000 to 100,000 Da. Typically, 50,000 to 80,000 Da, or more typically 60,000 to 70,000 Da.

According to one very specific embodiment, the homogenous polymer mixture comprises CAP in an amount of 55 to 80 weight-%. Typically, in an amount of 60 to 75 weight-%, or 65 to 75 weight-%. In the embodiment, the second polymer is preferably PBS and the mixture then comprises PBS in an amount of 20 to 40 weight-%. Typically, 25 to 40 weight-%, or 25 to 35 weight-%. Weight-%:s are based on the total weight of the composition. Optionally, the mixture comprises at least one additive such as softeners, pigments, stabilizers and/or other additives for use in plastic compositions. The CAP and PBS combination has shown good results in test preformed in connection with the present invention.

According to one embodiment, the homogenous polymer mixture comprises CAP in an amount of 55 to 80 weight-%, preferably 60 to 75 weight-%, more preferably 65 to 75 weight-%, and the second polymer in an amount of 20 to 40 weight-%, preferably 25 to 40 weight-%, more preferably 25 to 35 weight-%, based on the total weight of the composition, and optionally at least one additive such as softeners, pigments, dyes, stabilizers and/or other additives for use in plastic compositions.

According to one very specific embodiment, the homogenous polymer mixture consists of cellulose acetate propionate in an amount of 60 to 80 weight-%, typically 60 to 75 weight-%, or 65 to 75 weight-%, and PBS in an amount of 20 to 40 weight-%, typically 25 to 40 weight-% or 25 to 35 weight-%, based on the total weight of the composition, and optionally at least one additive such as softeners, pigments, dyes, stabilizers and/or other additives for use in plastic compositions.

According to one embodiment, the CAP has a number average molar mass of 30,000 to 110,000 Da; preferably 50,000 to 100,000 Da; more preferably 65,000 to 95,000 Da.

According to one embodiment, CAP has an acetyl content of 0.8 to 2.0 wt. %, more preferably 1.0 to 1.5 wt. %, and/or a propionyl content of 30 to 51 wt. %, more preferably 40 to 50 wt. %, and/or a hydroxyl content of 1.0 to 2.5 wt. %, more preferably 1.5 to 2.0 wt. %.

Suitably, the number average molar mass of the CAP polymer is above 20,000 Da. According to one embodiment, the number average molar mass is between 30,000 to 110,000 Da, typically between 50,000 to 100,000 Da, or 65,000 to 95,000 Da. The number average molar mass may be between 85,000 and 95,000 Da, or between 85,000 and 91,000 Da, for example 90,000 Da, 91,000 Da or 92,000 Da. A number average molar mass within the above defined ranges may provide a resilient material with mechanical properties that withstand processing.

All number average molar mass measurements performed in connection with the invention were measured with size exclusion chromatography (SEC) using chloroform eluent for the number average molar mass measurements. The SEC measurements were performed in chloroform eluent (0.6 ml/min, T=30° C.) using Styragel HR 4 and 3 columns with a pre-column. The elution curves were detected using Waters 2414 Refractive index detector. The molar mass distributions (MMD) were calculated against 10× PS (580−3040000 g/mol) standards, using Waters Empower 3 software.

Different grades of cellulose esters, such as cellulose acetate propionate, are commercially available from several suppliers. In the disclosed homogeneous polymer mixture, the polymer raw materials affect the properties of the formed mixture. In other words, the combined properties of the polymers need to be evaluated when forming the composition for the composite material according to the invention. For example, if one of the polymers has a high number average molar mass, such as 90,000 Da or 70,000 Da, it could be suitable to combine this polymer with another polymer having a lower number average molar mass. Alternatively, or additionally, a higher amount of softener may be used together with polymers with a high molar mass. The suitable number average molar mass depends on the end use of the composition, i.e. the most suitable cellulose ester grade may be different depending on the intended end use. Cellulose esters may have different grades of substitution. The CAP suitable for the composite of the present invention suitably has an acetyl content of 0.8 to 2.0 wt. %. Typically, 1.0 to 1.5 wt. %, for example 1.3 wt. %. The CAP suitable for the composite of the present invention suitably has a propionyl content of 30 to 51 wt. %. Typically, it may be 40 to 50 wt. %. A very specific example is 48 wt. %. The CAP suitable for the composite of the present invention suitably has hydroxyl content of 1.0 to 2.5 wt. %. Typically, 1.5 to 2.0 wt. %, for example 1.7 wt. %. In addition, the glass transition temperature is suitably 140 to 155° C. Typically, 142 to 152° C., for example 147° C.

According to one embodiment, the second polymer is PBS and the PBS suitable for the composite of the present invention has a number average molar mass in the range of 30,000 to 100,000 Da. Typically, 50,000 to 80,000 Da; or 60,000 to 70,000 Da. The number average molar mass of the PBS may be for example 65,000 to 70,000 Da, such as for example 68,000 Da, 69,000 Da or 70,000 Da.

Melt flow index (or melt flow rate) is a measure to describe ease of flow of the melt of a thermoplastic polymer or plastic. The melt flow index can be used to characterize a polymer or a polymer mixture. For polyolefins, i.e. polyethylene (PE, at 190° C.) and polypropylene (PP, at 230° C.) the MFI is commonly used to indicate order of magnitude for its melt viscosity. In standardized MFI measuring instrument a constant pressure generates shear stress which pushes melt plastic through a die. Typically, MFI is inversely proportional to molecular weight. For the homogenious polymer mixture in the solution of the invention the MFI was measured at two temperatures 215 and 240° C. According to one very specific embodiment, the homogenous polymer mixture has a melt flow index of 6 to 8 g/10 min. Suitably, about 7 g/10 min, or 6.9 g/10 min. Measured at: load 2.16 kg, at 215° C., and/or about 26 to 28 g/10 min, 27 g/10 min, or 27.1 g/10 min, load 2.16 kg, at 240° C.

According to one embodiment, the homogenous polymer mixture suitable for the solution according to the invention comprises another component in addition to CAP and the second polymer, which component is selected from the list consisting of a cellulose ester, such as cellulose acetate or cellulose acetate butyrate (CAB), an aliphatic or aliphatic aromatic polyester, such as polybutylene succinate adipate (PBSA) or polybutylene adipate terephthalate (PBAT), a polyhydroxyalkanoate (PHA), such as polyhydroxybutyrate (PHB), polylactic acid (PLA), and polycaprolactone (PCL). According to one embodiment, the homogenous polymer mixture comprises also other similar polymers, which are compatible with CAP and the second polymer, for example PBS.

The homogenious polymer mixture may also comprise other components, such as additives typically used in plastics. These additives are for example softeners or plasticizers, fillers, aids, pigments, stabilizers or other agents. Typically, the amounts of these additives vary between 0.01 to 10 weight-% based on the weight of the homogenious polymer composition used in the invention. The amount of one additive may for example be 0.1 to 5 weight-% based on the weight of the composition.

The invention also relates to an article manufactured from the thermoplastic composite material according to anyone of the described embodiments.

According to one embodiment of the invention, the article it is selected from the group consisting of packaging materials, deckings, automotive parts, paneling, sidings, fencing materials, technical parts, furniture, consumer goods; such as kitchenware, cutlery, tableware, cutting boards, trays, dishes, or beauty items, such as combs, hairbrushes, make up brushes and/or their handles, decorative items, toys, holders, retainers, containers, vases, pots, cases, boxes, frames, pens and/or pencils, fishing equipment, electronics casings and covers; such as loudspeaker casings, radio covers, mobile phone covers, other casings and/or covers. The composites according to the invention comprising metal particles, such as zink, copper and/or tungsten, could be suitable for use in applications like lures for fishing, automotive applications, where lead containing materials need to be replaced with more environmentally friendly alternatives.

The invention also relates to a method for manufacturing a thermoplastic composite material. The method comprises the following steps:
obtaining a homogenous polymer mixture comprising component A, which comprises a polymer composition comprising cellulose acetate propionate (CAP), and a second polymer selected from the group consisting of polybutylene succinate (PBS), polypropylene succinate (PPS), polybutylene succinate adipate (PBSA), polybutylene adipate terephthalate (PBAT), polylactic acid (PLA), polycaprolactone (PCL), polybutylene adipate (PBA), polyhydroxyalkanoate (PHA), polyhydroxybutyrate (PHB), polyethylene furanoate (PEF), polybutylene terephthalate (PBT), polybutylene succinate terephthalate (PBST), and any polyester containing sebacic and/or azelaic acid and/or dodecanedioic acid as dicarboxylic acid alone or in combination with terephthalic acid, and any combination of these,
feeding the obtained homogenous polymer mixture comprising component A and a component B, comprising solid particles and/or fibers, to a compounder and mixing, to obtain a thermoplastic composite material wherein component B is distributed within component A, and
cooling the obtained thermoplastic composite material.

An alternative to the above defined method could be to mix all constituents of the thermoplastic composite material at once, without separately obtaining a homogenious polymer mixture comprising component A.

According to one embodiment, the mixing of component A and component B in the compounder is performed at a temperature of at least 180° C., or at least 200° C., to obtain a thermoplastic composite material wherein component B is distributed within component A.

The obtained thermoplastic composite material may be the thermoplastic composite material according to any one of the above described embodiments.

According to one embodiment of the invention, obtaining a homogenous polymer mixture comprising component A is performed by melt-mixing, wherein the melt-mixing is performed at a temperature between 200° C. and 300° C. Typically, the temperature is between 200° C. and 270° C. It may also be between 210° C. and 250° C., or between 210° C. and 230° C.

According to one embodiment of the invention, the solid particles are selected from the group consisting of wood dust, wood particles, heat treated wood particles, wood shavings, wood fibers, celluose fibers, nanocellulose, lignin fibers, carbon fibers, metal particles, glass fibers, textile fibers, and thermoplastic fibers, and any combination of these.

According to one embodiment of the invention, the homogenous polymer mixture comprising component A is formed into a granulate before feeding it to the compounder together with component B.

According to one embodiment of the invention, the method further comprises a step wherein the obtained thermoplastic composite material is processed into an article using a method selected from the group consisting of injection molding, injection blow molding, injection stretch molding, 3D printing, deep drawing, rotational molding and thermoforming, and any combination of these.

According to one embodiment of the invention, the homogenous polymer mixture comprising component A is formed into a granulate before feeding it to the compounder together with component B.

The invention also relates to use of the thermoplastic composite material according to any one of the described embodiments in the manufacture of aricles selected from the group consisting of packaging materials, deckings, automotive parts, paneling, sidings, fencing materials, technical parts, furniture, consumer goods; such as kitchenware, cutlery, tableware, cutting boards, trays, dishes, or beauty items, such as combs, hairbrushes, make up brushes and/or their handles, decorative items, toys, holders, retainers, containers, vases, pots, cases, boxes, frames, fishing equipment pens and/or pencils, electronics casings and covers; such as loudspeaker casings, radio covers, mobile phone covers, other casings and/or covers.

The thermoplastic composite material according to the invention may also comprise other materials such as pigments, fillers, additives etc. The required or preferred other materials depend on the intended end use of the composite material.

The thermoplastic composite material or articles manufactured thereof may also be coated with various compositions. The coating may give the articles new beneficial properties, such as barrier properites, heat resistance, chemical recistance, solvent recistance etc.

Biocomposites can be a solution in reducing plastics in various applications. They can provide the required performance and processability. One advantage of the composite or biocomposite according to the invention is that the produced granulates can be processed with existing machines without major modifications, whether by injection moulding, extrusion or additive production (3D printing). Furthermore, improved mechanical properties can be obtained.

### EXAMPLES

Reference will now be made in detail to various embodiments, an example of which is illustrated in the accompanying drawings.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

For reasons of simplicity, item numbers will be maintained in the following exemplary embodiments in the case of repeating components.

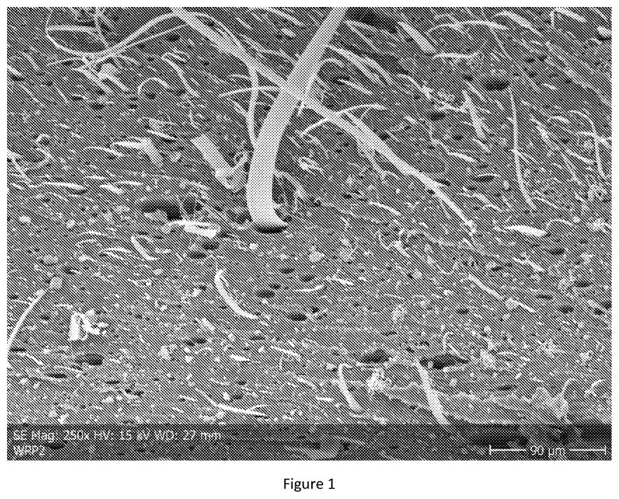

FIG. 1 illustrates sample 10 from example 2, and in-situ generated web of polypropylene in the matrix.

The following raw-materials defined in Table 1 and Table 2 have been used in the Examples.

TABLE 1
Cellulose acetate propionate (CAP)

| Entry | Compound | Mn g/mol | Mw g/mol | PD | Eluent/HPSEC system |
|---|---|---|---|---|---|
| 1 | CAP | 90,000 | 221,000 | 2.5 | Chloroform |

Cellulose acetate propionate had degree of substitution of:
acetyl content 1.2 wt %
propionyl content 48 wt %
hydroxyl content 1.7 wt %

TABLE 2
Polybutylene succinate (PBS)

| Entry | Compound | Mn g/mol | Mw g/mol | PD | Eluent/HPSEC system |
|---|---|---|---|---|---|
| 1 | PBS | 76,000 | 215,000 | 2.8 | Chloroform |

The number average molar mass measurements (Mn) were performed with size exclusion chromatography (SEC) using chloroform eluent for the number average molar mass measurements, the samples (Entries 1 to 4), were dissolved overnight using chloroform (concentration of 1 mg/ml). Samples were filtered (0.45 μm) before the measurement.

The SEC measurements were performed in chloroform eluent (0.6 ml/min, T=30° C.) using Styragel HR 4 and 3 columns with a pre-column. The elution curves were detected using Waters 2414 Refractive index detector. The molar mass distributions (MMD) were calculated against 10× PS (580−3,040,000 g/mol) standards, using Waters Empower 3 software.

Wood particles used were of thermally treated wood with high temperature tolerance. The wood particles were in the form of fine dust and were obtained by mechanical processing of thermally treated wood.

Polypropylene used had MFI (melt flow index) of 8.8 g/10 min (at 230° C. and 2.16 kg).

### Example 1: Biocomposites with CAP and PBS Polymer Blend as the Thermoplastic Matrix (Component A) and Wood Powder as the Filler (Component B)

The polymer mixture of the thermoplastic matrix (component A) was produced by melt mixing. The mixing was conducted at temperatures of 210-220° C. with a twin-screw compounder. The homogeneous polymer mixture of the thermoplastic matrix (component A) and the wood powder (component B) were fed to the twin-screw compounder and mixed at 205-220° C. The weight-% of the wood powder is the weight-% from the total composite mixture.

The impact strength of the composites is remarkably high with Sample 2 showing the reinforcement effect of the wood dust in the thermoplastic matrix.

The particles of the Wood 1 powder (component B) used in the tests had a typical particle length of about 1 mm. The particles had a flat shape and an elongated form. However, the wood particles were heterogeneous in size and shape as the average length varied from a few micrometers to a few centimeters. Most of the particles were of size category 1 mm.

TABLE 3
Test results

| | | | Tensile | Tensile | | Impact |
|---|---|---|---|---|---|---|
| | | | stress | strain | | strength |
| | | | at yield | at yield | Modulus | (kJ/m²) |
| Sample | Component A | Component B | (MPa) | (%) | (MPa) | (Notched = N) |
| 1 | CAP 70% | — | 24.1 | 3.9 | 1117 | 38.0 (N) |
| | PBS 30% | | | | | |
| 2 | CAP 70% | 5% Wood 1 | 26.2 | 5.8 | 537 | 74.1 |
| | PBS 30% | | | | | |
| 3 | CAP 70% | 10% Wood 1 | 29.1 | 4.5 | 742 | 31.1 |
| | PBS 30% | | | | | |
| 4 | CAP 70% | 20% Wood 1 | 29.2 | 3.4 | 875 | 13.4 |
| | PBS 30% | | | | | |
| 5 | CAP 70% | 30% Wood 1 | 28.0 | 2.6 | 1070 | 8.2 |
| | PBS 30% | | | | | |
| 6 | CAP 70% | 40% Wood 1 | 28.4 | 2.4 | 1120 | 7.9 |
| | PBS 30% | | | | | |
| 7 | CAP 70% | 20% Wood 2 | 31.3 | 3.0 | 1130 | 10.8 |
| | PBS 30% | | | | | |

### Example 2: Polypropylene Reinforced Composite

A biocomposite with CAP and PBS polymer blend as the thermoplastic matrix (component A) and polypropylene forming the reinforcing fibers (component B) was prepared.

Polypropylene fibers were generated in situ during the processing. The polypropylene filler is not homogeneously blended into the thermoplastic matrix formed by homogeneous polymer blend of CAP and PBS, but instead the polypropylene forms a fiber structure inside the CAP and PBS blend (FIG. 1, SEM image of Sample 10).

A relatively small amount of polypropylene (component B) was compounded in molten state together with bioplastic blend consisting of CAP and PBS (component A). The polypropylene content was 1 to 5% by weight. The polypropylene was selected such way that the melt flow index of PP was almost equal to that of CAP-PBS blend at the compounding temperature.

The impact strength values for the composite containing 5% of polypropylene indicated major increase compared to pure CAP-PBS blend and to pure PP. The SEM images taken from the cross-section of composites indicated that polypropylene has formed a network of microfibers inside the CAP-PBS blend. The fibers are disoriented and thus they form a network which makes the mechanical interlock between the matrix and the enforcing fibers strong against sudden impacts.

The impact strength of the composites is remarkably high with Sample 10 showing the reinforcement effect of the polypropylene fibers in the thermoplastic matrix.

TABLE 4
Test results

| | | | Tensile | Tensile | | Impact |
|---|---|---|---|---|---|---|
| | | | stress | strain | | strength |
| | | | at yield | at yield | Modulus | (kJ/m²) |
| Sample | Component A | Component B | (MPa) | (%) | (MPa) | (Notched = N) |
| 8 | CAP 72.5% | — | 28.4 | 3.9 | 1200 | 24.0 (N) |
| | PBS 27.5% | | | | | |
| 9 | — | Polypropylene | 24.8 | 9.8 | 924 | 4.6 (N) |
| 10 | CAP 72.5% | 5% Polypropylene | 26.5 | 3.8 | 1198 | 51.7 (N) |
| | PBS 27.5% | | | | | |

### Example 3: Composites with Other Fillers

Biocomposites with a CAP and PBS polymer blend as the thermoplastic matrix (component A) and various fillers (component B) were prepared. Composites comprising Vitacel wheat fiber, Arbocel highly pure cellulose, Arbocel cellulose, talc, and CaCO₃ as component B were prepared. The amount of component B was 5 weight-% (Table 5).

The impact strength values for the composites containing 5% component B were measured. The results showed that good composite materials were formed. Especially, the modulus of the composites was remarkably high with Samples 11 to 15 showing the reinforcement effect of the varius fillers in the thermoplastic matrix.

TABLE 5
Test results

| | | | Tensile | Tensile | | Impact |
|---|---|---|---|---|---|---|
| | | | stress | strain | | strength |
| | | | at yield | at yield | Modulus | (kJ/m²) |
| Sample | Component A | Component B | (MPa) | (%) | (MPa) | (Notched = N) |
| 11 (WCP-09) | CAP 70% | 5% Vitacel | 24.2 | 9.8 | 1324 | 14.7 (N) |
| | PBS 30% | wheat fiber | | | | |
| | | grade WF | | | | |
| | | 600-30 | | | | |
| 12 (WCP-10) | CAP 70% | 5% Arbocel | 24.6 | 3.8 | 1326 | 15.0 (N) |
| | PBS 30% | highly pure | | | | |
| | | cellulose | | | | |
| | | grade BE | | | | |
| | | 600-30 | | | | |
| 13 (WCP-11) | CAP 70% | 5% Arbocel | 25.1 | 3.9 | 1316 | 15.5 (N) |
| | PBS 30% | cellulose | | | | |
| | | grade CW | | | | |
| | | 630 PU | | | | |
| 14 (WCP-12) | CAP 70% | 5% Arbocel | 24.5 | 3.7 | 1302 | 17.5 (N) |
| | PBS 30% | cellulose | | | | |
| | | grade G350 | | | | |
| 15 (WCP-13) | CAP 70% | 5% Talc | 24.4 | 3.8 | 1375 | 22.3 (N) |
| | PBS 30% | | | | | |
| 16 (WCP-14) | CAP 70% | 5% CaCO3 | 19.0 | 14.3 | 982 | 24.3 (N) |
| | PBS 30% | FP-Val-Forte | | | | |
| | | FG SA | | | | |

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A product, a system, a method, or a use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A thermoplastic composite material, wherein it comprises in combination
component A, which is a continuous matrix based on a homogeneous polymer mixture comprising a polymer composition comprising cellulose acetate propionate (CAP), and a second polymer selected from the group consisting of polybutylene succinate (PBS), polypropylene succinate (PPS), polybutylene succinate adipate (PBSA), polybutylene adipate terephthalate (PBAT), polylactic acid (PLA), polycaprolactone (PCL), polybutylene adipate (PBA), polyhydroxyalkanoate (PHA), polyhydroxybutyrate (PHB), polyethylene furanoate (PEF), polybutylene terephthalate (PBT), polybutylene succinate terephthalate (PBST), and any polyester containing sebacic and/or azelaic acid and/or dodecanedioic acid as dicarboxylic acid alone or in combination with terephthalic acid, and any combination of these, and
a component B, which comprises solid particles and/or fibers distributed within said continuous matrix,
in an amount of at least 80 weight-% of the total weight of the thermoplastic composite material, and
wherein the thermoplastic composite material comprises at least 1 weight-% of component B based on the total weight the thermoplastic composite material.

2. The thermoplastic composite material according to claim 1, wherein the solid particles and/or fibers are selected from the group consisting of wood dust, wood particles, heat treated wood particles, wood shavings, wood fibers, celluose fibers, nanocellulose, lignin fibers, carbon fibers, metal particles, glass fibers, textile fibers and thermoplastic polymer fibers, and any combination of these.

3. The thermoplastic composite material according to claim 1, wherein the composite material comprises 25 to 99 weight-% of component A, and 1 to 75 weight-% of component B, based on the total weight of the thermoplastic composite material.

4. The thermoplastic composite material according to claim 1, wherein the component A is a homogeneous polymer mixture comprising CAP and said second polymer in an amount of at least 80 weigh-%, preferably at least 90 weight-% based on the total weight of the weight of the homogenous polymer mixture.

5. The thermoplastic composite material according to claim 1, wherein that the component B comprises at least 80 weigh-%, typically at least 90 weight-% of said solid particles and/or fibers, based on the total weight of the solid particles and/or fibers.

6. The thermoplastic composite material according to claim 1, wherein that in component B, the sieve particle size of the solid particles is 1μm to 5000 μm, or 1μm to 3000 μm, typically 5 to 2000 μm.

7. The thermoplastic composite material according to claim 1, wherein that the solid particles and/or fibers of component B are selected from the group consisting of wood dust, wood particles, heat treated wood particles, wood shavings, wood fibers and any combination of these, with a sieve particle size in the range of 100 to 3000 μm, typically 200 to 2000 μm.

8. The thermoplastic composite material according to claim 1, wherein that the composite material comprises 30 to 99 weight-% of component A, and 1 to 70 weight-% of component B, based on the total weight of the thermoplastic composite material.

9. The thermoplastic composite material according to claim 1, wherein that component B comprises thermoplastic polymer fibers, which are fibers that are non-miscible to the first matrix, for example polypropylene, and/or polyethylene.

10. The thermoplastic composite material according to claim 1, wherein that component B is selected from metal particles selected from the group consisting of copper, zinc and tungsten, and any combination of these.

11. The thermoplastic composite material according to claim 1, wherein component B is selected from the group consisting of talc, CaCO3, carbon black and kaolin, and any combination or mixture of these.

12. An article manufactured from the thermoplastic composite material according to claim 1.

13. The article according to claim 12, wherein is selected from the group consisting of packaging materials, deckings, automotive parts, paneling, sidings, fencing materials, technical parts, furniture, consumer goods; such as kitchenware, cutlery, tableware, cutting boards, trays, dishes, or beauty items, such as combs, hairbrushes, make up brushes and/or their handles, decorative items, toys, holders, retainers, containers, vases, pots, cases, boxes, frames, fishing equipment, pens and/or pencils, electronics casings and covers; such as loudspeaker casings, radio covers, mobile phone covers, other casings and/or covers.

14. A method for manufacturing a thermoplastic composite material, wherein the method comprises the following steps:
obtaining a homogenous polymer mixture comprising component A, which comprises a polymer composition comprising cellulose acetate propionate (CAP), and a second polymer selected from the group consisting of polybutylene succinate (PBS), polypropylene succinate (PPS), polybutylene succinate adipate (PBSA), polybutylene adipate terephthalate (PBAT), polylactic acid (PLA), polycaprolactone (PCL), polybutylene adipate (PBA), polyhydroxyalkanoate (PHA), polyhydroxybutyrate (PHB), polyethylene furanoate (PEF), polybutylene terephthalate (PBT), polybutylene succinate terephthalate (PBST), and any polyester containing sebacic and/or azelaic acid and/or dodecanedioic acid as dicarboxylic acid alone or in combination with terephthalic acid, and any combination of these,
feeding the obtained homogenous polymer mixture comprising component A and a component B, comprising solid particles and/or fibers, to a compounder and mixing, to obtain a thermoplastic composite material wherein component B is distributed within component A, and
cooling the obtained thermoplastic composite material.

15. The method according to claim 14, wherein obtaining a homogenous polymer mixture comprising component A is performed by melt-mixing, wherein the melt-mixing is performed at a temperature between 200° C. and 300° C., preferably between 200° C. and 270° C., more preferably between 210° C. and 250° C., even more preferably between 210° C. and 230° C.

16. The method according to claim 14, wherein the solid particles are selected from the group consisting of wood dust, wood particles, heat treated wood particles, wood shavings, wood fibers, celluose fibers, nanocellulose, lignin fibers, carbon fibers, metal particles, glass fibers, textile fibers, and thermoplastic fibers, and any combination of these.

17. The method according to claim 14, wherein the thermoplastic composite material is the thermoplastic composite material according to claim 1.

18. The method according to claim 14, wherein the method further comprises a step wherein the obtained thermoplastic composite material is processed into an article using a method selected from the group consisting of injection molding, injection blow molding, injection stretch molding, 3D printing, deep drawing, rotational molding, and thermoforming, and any combination of these.

19. The method according to claim 14, wherein said homogenous polymer mixture comprising component A is formed into a granulate before feeding it to the compounder together with component B.

20. The method according to claim 14, wherein that mixing of component A and component B in the compounder is performed at a temperature of at least 180° C., or at least 200° C., to obtain a thermoplastic composite material.

21. (canceled)
